(19) United States
(12) Patent Application Publication
(10) Pub. No.: US 2016/0274347 A1
(43) Pub. Date: Sep. 22, 2016

(54) MICROSCOPE SYSTEM

(71) Applicant: OLYMPUS CORPORATION, Tokyo (JP)

(72) Inventor: Masashi OKABE, Tokyo (JP)

(73) Assignee: OLYMPUS CORPORATION, Tokyo (JP)

(21) Appl. No.: 14/945,963

(22) Filed: Nov. 19, 2015

(30) Foreign Application Priority Data
Mar. 20, 2015 (JP) 2015-057619

(51) Int. Cl. G02B 21/36; H04N 9/73; H04N 5/232

(52) U.S. Cl. CPC G02B 21/365; H04N 5/23296; H04N 9/735; H04N 5/23212

(57) ABSTRACT

A microscope system including an optical microscope for observing a specimen, an image-acquisition portion that performs image acquisition of an image of the specimen obtained by the optical microscope, a monitor that displays the image of the specimen acquired by the image-acquisition portion, a region-of-interest setting portion that sets, in the image of the specimen, a region-of-interest that is being observed by the observer on the monitor, and an exposure control portion that controls the exposure level of the image-acquisition portion based on the brightness of the region-of-interest set in the image of the specimen by the region-of-interest setting portion.

### CROSS-REFERENCE TO RELATED APPLICATIONS

This application is based on Japanese Patent Application No. 2015-057619 filed on Mar. 20, 2015, the contents of which are incorporated herein by reference.

### TECHNICAL FIELD

The present invention relates to a microscope system and relates, in particular, to a microscope system having an automatic exposure (AE) function for a digital camera.

### BACKGROUND ART

In the related art, there are known microscope systems having an AE function for automatically adjusting the exposure level of a digital camera so that the brightness of an image will be appropriate (for example, see Patent Literatures 1 and 2). With the AE function, the brightness of an image acquired by the camera is measured, and the exposure level of the camera is adjusted so that the measured value reaches a predetermined target value. A region in which the brightness is measured at this time is generally set in advance to the entirety of the image or the center region thereof.

When a region-of-interest in a specimen needs to be observed in greater detail while, by means of a camera, performing live observation of an optical image of the specimen acquired by using a microscope, digital zoom is used, whereby the region-of-interest in the image displayed on the monitor is displayed by being enlarged by means of digital processing. With digital zoom, because the optical magnification of the microscope and camera are not changed, the camera's image-acquisition area on the specimen remains the same, and the position in the region in which the brightness is measured for the AE function also remains the same. Therefore, an appropriate exposure level for the brightness of the entire image sometimes differs from an appropriate exposure level for the brightness of the region-of-interest that the observer is actually observing on the monitor.

Such situations tend to occur when observing a specimen formed of a high-reflectance material such as a metal or the like. For example, because a soldered portion exhibits extremely high luminance due to halation as compared with surrounding areas, the appropriate exposure level for the brightness of the entire image-acquisition area greatly differs from the appropriate light exposure level for the brightness of the soldered portion.

### CITATION LIST

### {Patent Literature}

{PTL 1} Japanese Unexamined Patent Application, Publication No. 2013-152334

{PTL 2} Japanese Unexamined Patent Application, Publication No. 2010-161664

### SUMMARY OF INVENTION

The present invention provides a microscope system including an optical microscope for observing a specimen; an image-acquisition portion that performs image acquisition of an image of the specimen obtained by the optical microscope; a display portion that displays the image of the specimen acquired by the image-acquisition portion; a region-of-interest setting portion that sets, in the image of the specimen, a region-of-interest that is being observed by an observer on the display portion; and an exposure control portion that controls an exposure level of the image-acquisition portion based on a brightness of the region-of-interest set in the image of the specimen by the region-of-interest setting portion.

### BRIEF DESCRIPTION OF DRAWINGS

FIG. 1 is an overall configuration diagram of a microscope system according to a first embodiment of the present invention.

FIG. 2A is a diagram for explaining digital zoom processing performed by the microscope system in FIG. 1, showing an image acquired by an image-acquisition portion thereof at the original size.

FIG. 2B shows an enlarged image generated from the image at the original size in FIG. 2A.

FIG. 2C shows an enlarged image of FIG. 2B as displayed on a monitor.

FIG. 3 is a flowchart showing AE adjusting processing and digital zoom processing performed by the microscope system in FIG. 1.

FIG. 4 is an overall configuration diagram of a microscope system according to a second embodiment of the present invention.

FIG. 5 is an overall configuration diagram of a microscope system according to a third embodiment of the present invention.

FIG. 6 is an overall configuration diagram of a microscope system according to a fourth embodiment of the present invention.

### DESCRIPTION OF EMBODIMENTS

### First Embodiment

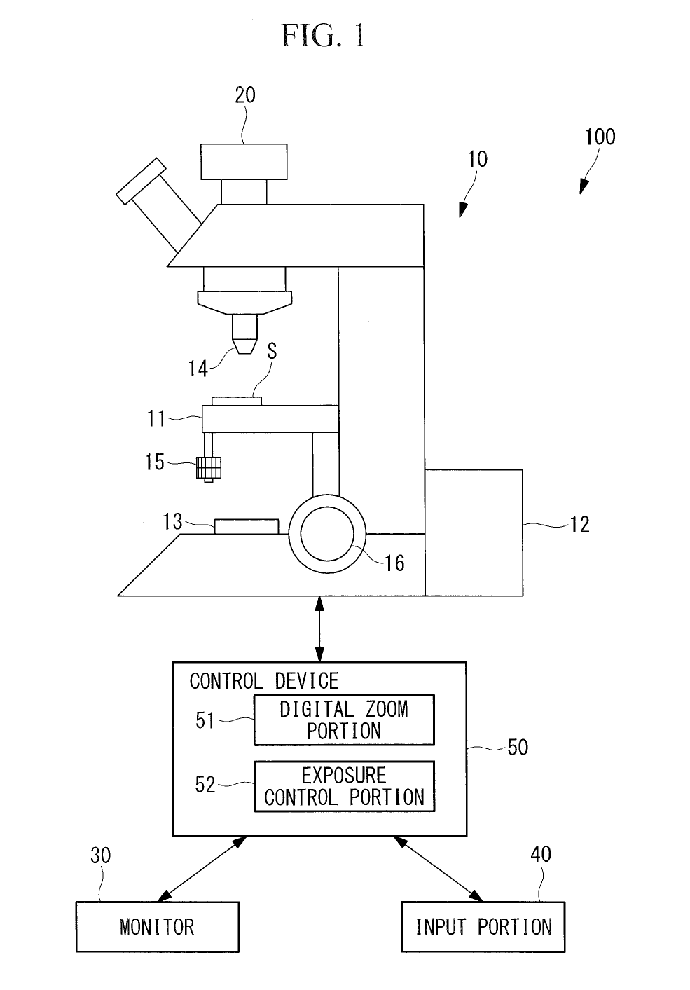

A microscope system 100 according to a first embodiment of the present invention will be described with reference to FIGS. 1 to 3.

As shown in FIG. 1, the microscope system 100 according to this embodiment is provided with an optical microscope 10 with which a specimen S is observed, an image-acquisition portion 20 that performs image acquisition of an optical image of the specimen S obtained by using the optical microscope 10, a monitor (display portion) 30 that displays the image of the specimen S acquired by using the optical microscope 10, an input portion 40 with which an observer performs input operations, and a control device 50 that controls the optical microscope 10, the image-acquisition portion 20, the monitor 30, and the input portion 40.

The optical microscope 10 is provided with a horizontally arranged stage 11, a light source 12, a condenser 13 that makes illumination light emitted from the light source 12 converge to be radiated onto the specimen S that is mounted on the stage 11, an objective lens 14 that collects light coming from the specimen S, an X-Y handle 15 that moves the stage 11 in horizontal directions (X- and Y-directions), and a Z-axis focusing handle 16 that moves the stage 11 and the objective lens 14 relative to each other in the vertical direction (Z-direction). Although the optical microscope 10 shown in FIG. 1 is an upright type, an inverted-type optical microscope may be employed.

The image-acquisition portion 20 is a digital camera (for example, a CCD camera, a CMOS camera, or a video camera) that is connected to a camera port of the optical microscope 10. The light coming from the specimen S that has been collected by the objective lens 14 is guided to the image-acquisition portion 20 via an image-forming lens (not shown) and the camera port so as to form an image at an image-acquisition surface of the image-acquisition portion 20 via the image-forming lens.

The image-acquisition portion 20 has a live-view mode in which image acquisition and transmission of the acquired images to the control device 50 are continuously executed at a certain frame rate. Images acquired in the live-view mode are sequentially transmitted to the monitor 30 from the control device 50 so as to be displayed on the monitor 30 as a live image (video image). Here, the control device 50 applies digital zoom processing (described below) to the image as needed, and then transmits the image to the monitor 30.

The input portion 40 is provided with, for example, input devices (not shown) such as a keyboard, a mouse, and so forth, and is connected to the control device 50. The observer can input operating conditions for the optical microscope 10 and the image-acquisition portion 20, and display settings for the monitor 30, by using the input portion 40.

In addition, the input portion 40 is configured so as to select one of an original-size display, in which the entirety of an image acquired by the image-acquisition portion 20 is displayed on the monitor 30, and an enlarged display, in which a portion of an image subjected to the digital zoom processing is displayed, in accordance with digital zoom operations (for example, keyboard inputs and mouse operations) by the observer. In addition, when the enlarged display is selected, the input portion 40 allows the observer to input the display magnification and display position by means of input operations (for example, keyboard inputs and mouse operations). When the enlarged display is selected, the input portion 40 transmits input information about the display magnification and display position to the control device 50.

The control device 50 is a PC (personal computer) having, for example, a CPU (Central Processing Unit), an auxiliary storage device such as a hard disk or the like, and a main storage device such as a RAM (Random Access Memory) or the like. The auxiliary storage device stores control software. The control device 50 is configured so as to control the optical microscope 10, the image-acquisition portion 20, and the monitor 30 based on the conditions input by the observer via the input portion 40 by means of the CPU being operated in accordance with the control software.

The control device 50 is provided with a digital zoom portion 51 that applies the digital zoom processing to an image that has been received from the image-acquisition portion 20 and that has the original size (hereinafter, referred to as an “original-size image”) and an exposure control portion (region-of-interest setting portion) 52 that controls the exposure time (exposure level) of the image-acquisition portion 20. Functions of the digital zoom portion 51 and the exposure control portion 52 (described below) are also realized by means of the CPU being operated in accordance with the control software.

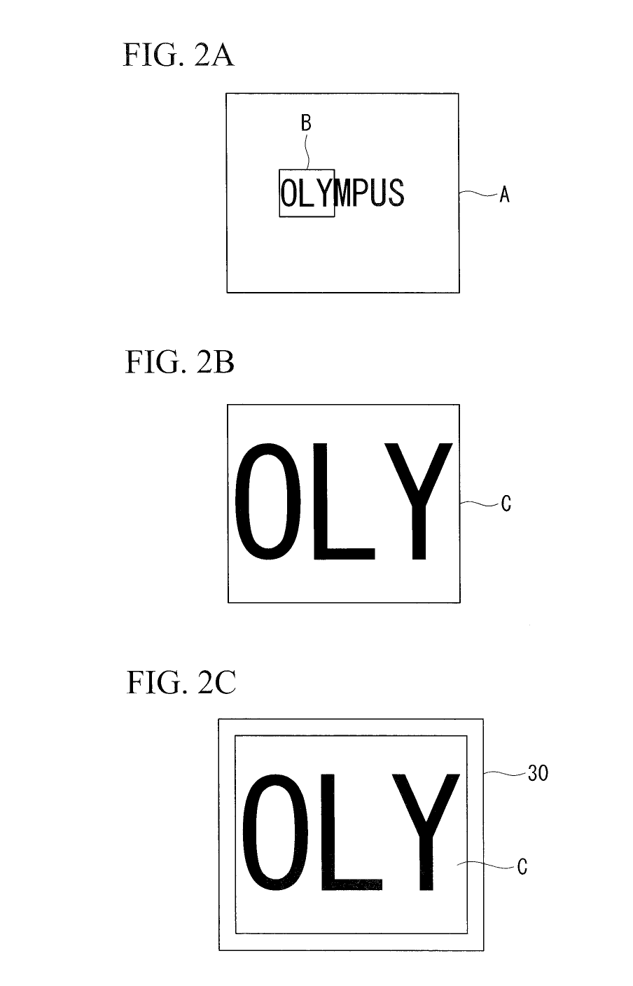

When the enlarged display is selected via the input portion 40, the digital zoom portion 51 sets, in the original-size image A, an enlargement region B to be subjected to the digital zoom processing based on the information about the display magnification and display position received from the input portion 40, as shown in FIG. 2A. Next, the digital zoom portion 51 cuts out the enlargement region B from the original-size image A, generates an enlarged image C by means of digital processing by enlarging the cut-out enlargement region B at the display magnification received from the input portion 40, as shown in FIG. 2B, and transmits the generated enlarged image C to the monitor 30. By doing so, as shown in FIG. 2C, the enlarged image C, which is a portion of the original-size image A that has been enlarged by means of the digital zoom processing, is displayed on the monitor 30.

The exposure control portion 52 sets a brightness-measurement region in the original-size image A, and calculates a representative luminance value (for example, an average or a median of luminance values of all pixels constituting the enlargement region B) for the set brightness-measurement region in the form of the brightness of the original-size image A.

At this time, when the original-size display is selected via the input portion 40, the exposure control portion 52 sets an initially set region (region-of-interest) in the original-size image A to serve as the brightness-measurement region. An initially set region is a region to which the observer pays attention when observing the original-size image A, for example, the center region or the entire region of the original-size image A, and is a region that is set in advance.

On the other hand, when the enlarged display is selected via the input portion 40, the exposure control portion 52 sets the enlargement region (region-of-interest) B, which has been set in the original-size image A by the digital zoom portion 51, to serve as the brightness-measurement region. Specifically, when a portion of an image is digitally zoomed, a region that is currently displayed on the monitor 30 is set to serve as the brightness-measurement region. By doing so, in association with digital zooming, the region displayed on the monitor 30 can be automatically set to serve as the brightness-measurement region.

Next, based on the calculated representative luminance value and an exposure time used by the image-acquisition portion 20 in the immediately preceding image acquisition, the exposure control portion 52 calculates an exposure time to be used in the subsequent image acquisition. Specifically, in the case in which the representative luminance value is greater than a predetermined target value, the exposure control portion 52 makes the subsequent exposure time shorter than the immediately preceding exposure time; in the case in which the representative luminance value is less than the predetermined target value, the exposure control portion 52 makes the subsequent exposure time longer than the immediately preceding exposure time; and, by doing so, the exposure control portion 52 sets the subsequent exposure time so that the representative luminance value of the next image to be acquired by the image-acquisition portion 20 approaches the predetermined target value. The exposure control portion 52 causes the image-acquisition portion 20 to execute the next image acquisition by using the set exposure time.

Next, the operation of the microscope system 100 will be described.

When the specimen S is mounted on the stage 11 and the illumination light is emitted from the light source 12, the illumination light is radiated onto the specimen S on the stage 11 by the condenser 13. Light coming from the specimen S (for example, illumination light that has passed through the specimen S) is collected by the objective lens 14 and is subjected to the image acquisition by the image-acquisition portion 20 via the image-forming lens (not shown). The image acquired by the image-acquisition portion 20 is transmitted to the monitor 30 via the control device 50 and is displayed on the monitor 30. Here, by operating the image-acquisition portion 20 in the live-view mode, it is possible to perform, on the monitor 30, live observation of the optical image of the specimen S that is currently being observed by the optical microscope 10.

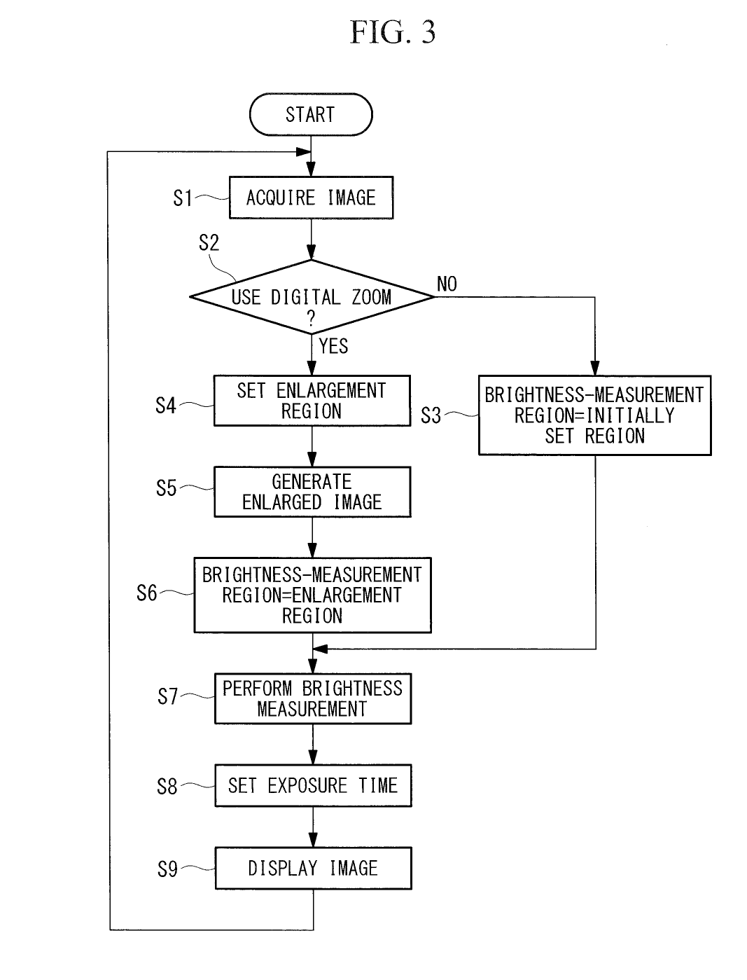

Here, the image displayed on the monitor 30 is subjected to the automatic exposure (AE) adjustment by the control device 50 and is additionally subjected to the digital zoom processing in accordance with the digital zoom operations by the observer. FIG. 3 is a flowchart showing the AE adjusting processing and the digital zoom processing performed by the control device 50.

As shown in FIG. 3, in the case in which the original-size display is selected via the input portion 40 (“No” in step S2), when the original-size image A is transmitted to the control device 50 from the image-acquisition portion 20 (step S1), the original-size image A is transmitted to and displayed on the monitor 30 in the original size (step S9).

At this time, the exposure control portion 52 sets the initially set region in the original-size image A to serve as the brightness-measurement region (step S3), measures the brightness of the initially set region (step S7), and sets the exposure time for the subsequent image acquisition based on the brightness of the initially set region (step S8). By doing so, the next image to be acquired by the image-acquisition portion 20 will be an image in which exposure thereof is adjusted so that the brightness in the initially set region, for example, the center region or the entire region thereof, is optimized.

On the other hand, in the case in which the enlarged display is selected via the input portion 40 by the digital zoom operations performed by the observer via the input portion 40 (“YES” in step S2), when the original-size image A is transmitted to the control device 50 from the image-acquisition portion 20 (step S1), the digital zoom portion 51 applies the digital zoom processing to the original-size image A. Specifically, the enlargement region B is set in the original-size image A based on the display magnification and display position that have been input to the input portion 40 (step S4), an enlarged image C in which the enlargement region B is enlarged by the digital processing is generated (step S5), and the enlarged image C is displayed on the monitor 30 (step S9).

At this time, the exposure control portion 52 sets the enlargement region B in the original-size image A, which has been subjected to the digital zoom processing in steps S4 and S5, to serve as the brightness-measurement region (step S6), measures the brightness of the enlargement region B (step S7), and sets the exposure time for the subsequent image acquisition based on the brightness of the enlargement region B (step S8). By doing so, the next image to be acquired by the image-acquisition portion 20 will be an image whose exposure thereof is adjusted so that the brightness in the enlargement region B is optimized.

As has been described above, with this embodiment, the observer can perform detailed observation by displaying a portion of the image-acquisition area on the monitor 30 in an enlarged display by means of the digital zoom operations via the input portion 40, while continuing live observation of the same image-acquisition area of the specimen S by means of the image-acquisition portion 20. At this time, if the image displayed on the monitor 30 is changed to the enlarged image C from the original-size image A, the brightness-measurement region is also changed to the enlargement region B from the initially set region. Similarly, if the image displayed on the monitor 30 is changed to another enlarged image C with a different display magnification and display position from the enlarged image C, the brightness-measurement region is also changed from the enlargement region B to another enlargement region B.

As has been described above, by changing the brightness-measurement region, in association with the digital zoom processing, so that a display region in the original-size image A that is actually displayed on the monitor 30 serves as the brightness-measurement region, there is an advantage in that, even when performing live observation of a specimen S having high contrast, it is possible to display the display region being observed by the observer on the monitor 30 at the optimal brightness. Furthermore, because the brightness-measurement region is automatically updated, in association with the digital zoom operations performed by the observer via the input portion 40, the observer does not need to perform operations for resetting the brightness-measurement region separately from the digital zoom operations. Therefore, there is an advantage in that, in the case in which, for example, digital zoom observation is repeated at numerous positions in the same image-acquisition area, the observer can efficiently perform a series of observations without interrupting the digital zoom operations.

### Second Embodiment

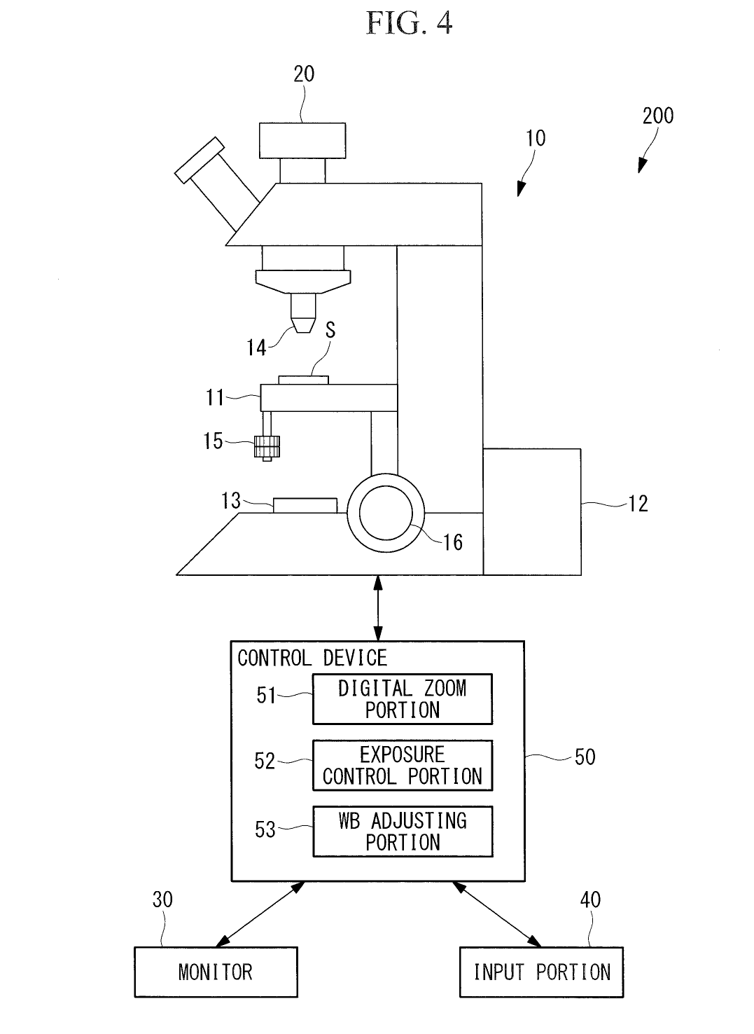

A microscope system 200 according to a second embodiment of the present invention will be described with reference to FIG. 4.

The microscope system 200 according to this embodiment differs from that of the first embodiment in that an Auto White Balance (AWB) function is additionally provided. Specifically, in the microscope system 200, the control device 50 is further provided with a white-balance (WB) adjusting portion 53, as shown in FIG. 4. Therefore, the WB adjusting portion 53 will mainly be described in this embodiment, and configurations in common with the above-described microscope system 100 will be given the same reference signs, and descriptions thereof will be omitted.

The WB adjusting portion 53 sets a color-measurement region in the original-size image A, and executes WB processing for the original-size image A based on the color of the set color-measurement region. The WB processing is, for example, processing with which signals of pixels in the color-measurement region are separated into R signals, G signals, and B signals and with which the gains of the R signals, the G signals, and the B signals of the individual pixels of the original-size image A are adjusted so that the ratios among the average of the R signals, the average of the G signals, and the average of the B signals reach predetermined ratios.

At this time, when the original-size display is selected via the input portion 40, the WB adjusting portion 53 sets the initially set region (region-of-interest) in the original-size image A to serve as the color-measurement region. The initially set region is a region set in advance, for example, the center region or the entire region of the original-size image A. On the other hand, when the enlarged display is selected via the input portion 40, the WB adjusting portion 53 sets the enlargement region (region-of-interest) B, which has been set in the original-size image A by the digital zoom portion 51, to serve as the color-measurement region.

The control software is designed so as to also realize the above-described functions of the WB adjusting portion 53 by means of the CPU.

Next, the operation of the microscope system 200 will be described.

In this embodiment, in addition to the AE adjusting processing and the digital zoom processing described above, Auto White Balance (AWB) adjusting processing, described below, is executed by the control device 50.

When the original-size display is selected via the input portion 40, the WB adjusting portion 53 sets the initially set region in the original-size image A to serve as the color-measurement region, measures the color of the initially set region, and adjusts the white balance of the original-size image A based on the color of the initially set region. Then, the original-size image A whose white balance has been adjusted is displayed on the monitor 30.

On the other hand, in the case in which the enlarged display is selected via the input portion 40 by the digital zoom operations performed by the observer via the input portion 40, the WB adjusting portion 53 sets the enlargement region B, which has been set in the original-size image A in step S4 described above, to serve as the color-measurement region, measures the color of the enlargement region B, and performs the WB adjustment of the original-size image A based on the color of the enlargement region B. Then, the enlarged image C that is generated from the WB-adjusted original-size image A is displayed on the monitor 30.

As has been described above, with this embodiment, if a display region in the original-size image A displayed on the monitor 30 is changed by the digital zoom operations by the observer, the color-measurement region is also changed so that the display region that is actually displayed on the monitor 30 serves as the color-measurement region. By doing so, there is an advantage in that, in live observation, it is possible to display the display region being observed by the observer on the monitor 30 with an optimal white balance. Furthermore, because the color-measurement region is automatically updated, in association with the digital zoom operations performed by the observer via the input portion 40, the observer does not need to perform operations for resetting the color-measurement region separately from the digital zoom operations. Because other effects of this embodiment are the same as those of the first embodiment, descriptions thereof will be omitted.

### Third Embodiment

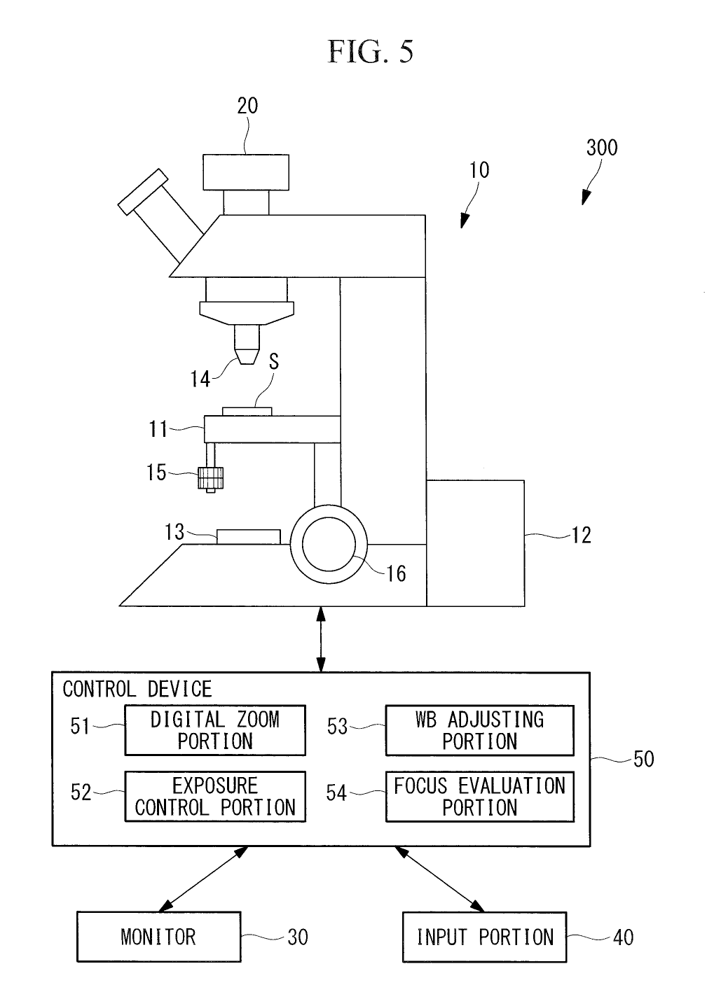

A microscope system 300 according to a third embodiment of the present invention will be described below with reference to FIG. 5.

The microscope system 300 according to this embodiment differs from that of the second embodiment in that a focus evaluation function is additionally provided. Specifically, in the microscope system 300, the control device 50 is further provided with a focus evaluation portion 54, as shown in FIG. 5. Therefore, the focus evaluation portion 54 will mainly be described in this embodiment, and configurations in common with the above-described microscope systems 100 and 200 will be given the same reference signs, and descriptions thereof will be omitted.

The focus evaluation portion 54 sets a focus-evaluation region in the original-size image A and calculates a focus evaluation value that indicates the degree-of-focus in the set focus-evaluation region. The focus evaluation value is, for example, a contrast value that is calculated based on an edge component and a high spatial frequency component in the focus-evaluation region. The focus evaluation value reaches a maximum when the focal point of the objective lens 14 of the optical microscope 10 coincides with the specimen S, and gradually decreases as the focal point of the objective lens 14 shifts away from the specimen S in the Z-direction.

At this time, when the original-size display is selected via the input portion 40, the focus evaluation portion 54 sets the initially set region (region-of-interest) in the original-size image A to serve as the focus-evaluation region. The initially set region is a region set in advance, for example, the center region or the entire region of the original-size image A. On the other hand, when the enlarged display is selected via the input portion 40, the focus evaluation portion 54 sets the enlargement region (region-of-interest) B, which has been set in the original-size image A by the digital zoom portion 51, to serve as the focus-evaluation region. By doing so, it is possible to evaluate the quality of focus in the region-of-interest based on the focus evaluation value.

The focus evaluation portion 54 generates a focus indicator that visually expresses the calculated focus evaluation value, and transmits the generated focus indicator to the monitor 30. The monitor 30 displays the received focus indicator together with the image A or C of the specimen S.

The control software is designed to also realize the above-described functions of the focus evaluation portion 54 by means of the CPU. Next, the operation of the microscope system 300 will be described.

In this embodiment, in addition to the AE adjusting processing, the digital zoom processing, and the AWB adjusting processing described above, focus evaluating processing, described below, is executed by the control device 50.

When the original-size display is selected via the input portion 40, the focus evaluation portion 54 sets the initially set region in the original-size image A to serve as the focus-evaluation region and calculates the focus evaluation value for the initially set region. On the other hand, when the enlarged display is selected via the input portion 40 by the digital zoom operations performed by the observer via the input portion 40, the focus evaluation portion 54 sets the enlargement region B, which has been set in the original-size image A in step S4 described above, to serve as the focus-evaluation region and calculates the focus evaluation value for the enlargement region B.

Next, the focus evaluation portion 54 generates a focus indicator that expresses the calculated focus evaluation value, and the generated focus indicator is displayed on the monitor 30.

For example, when observing a specimen S having height differences in the Z-direction, the states of focus in the enlarged image C differ depending on positions in the specimen S shown in enlarged display when performing digital zoom. Therefore, the observer can recognize whether or not the enlargement region B currently being observed on the monitor 30 is in focus by checking the focus indicator, and, if not in focus, he or she can adjust the focus to optimize it based on the focus indicator by manually manipulating the Z-axis focusing handle 16.

In this case, with this embodiment, if a display region in the original-size image A displayed on the monitor 30 is changed by the digital zoom operations by the observer, the focus-evaluation region is also changed so that the display region that is actually displayed on the monitor 30 serves as the focus-evaluation region. By doing so, there is an advantage in that, in live observation, it is possible to allow the observer to accurately recognize, by means of the focus indicator, the states of focus in the display region that the observer is observing on the monitor 30. Because other effects of this embodiment are the same as those of the first and second embodiments, descriptions thereof will be omitted.

### Fourth Embodiment

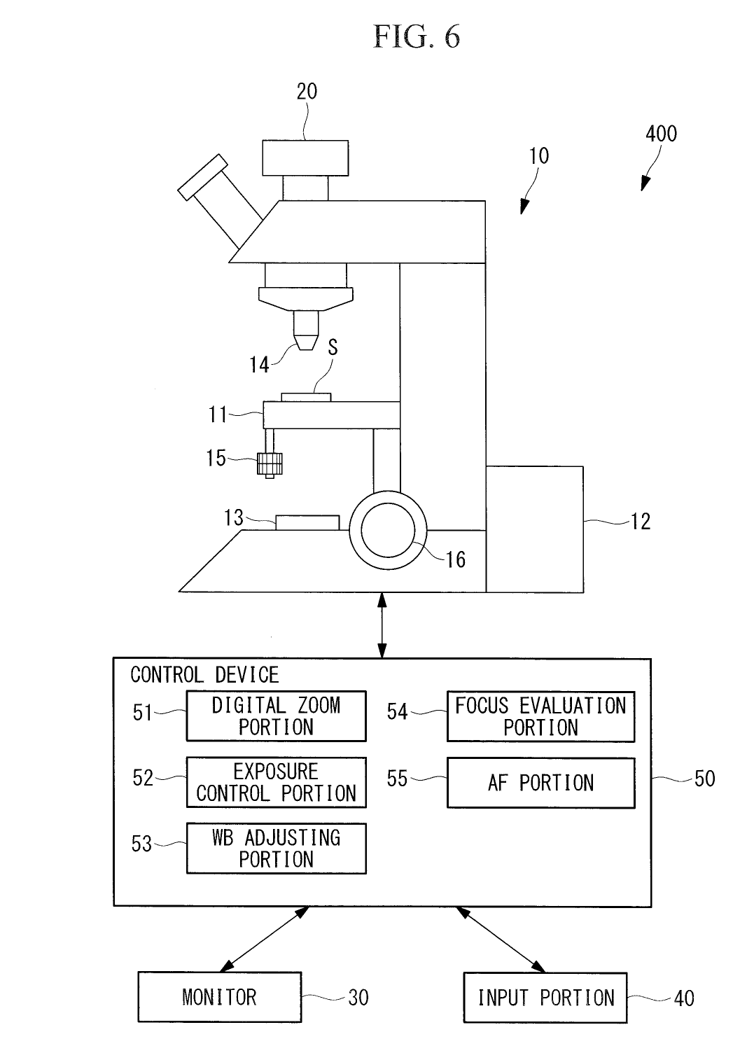

A microscope system 400 according to a fourth embodiment of the present invention will be described below with reference to FIG. 6.

The microscope system 400 according to this embodiment differs from that of the third embodiment in that an autofocus (AF) function is additionally provided. Specifically, in the microscope system 400, the control device 50 is further provided with an AF portion (focus adjusting portion) 55, as shown in FIG. 6. Therefore, the AF portion 55 will mainly be described in this embodiment, and configurations in common with the above-described microscope systems 100, 200, and 300 will be given the same reference signs, and descriptions thereof will be omitted.

In this embodiment, the stage 11 is an electrically powered stage that can electrically be driven in X-, Y-, and Z-directions by means of a motor (not shown).

The focus evaluation portion 54 transmits the calculated focus evaluation value to the AF portion 55.

The AF portion 55 moves the stage 11 in the Z-direction by controlling driving of the motor based on the focus evaluation values received from the focus evaluation portion 54, and positions the stage 11 at a Z-direction position where the focus evaluation values reach a maximum.

The control software is designed to also realize the above-described functions of the AF portion 55 by means of the CPU.

Next, the operation of the microscope system 400 will be described.

In this embodiment, in addition to the AE adjusting processing, the digital zoom processing, the AWB adjusting processing, and the focus evaluating processing described above, the AF adjusting processing, described below, is executed by the control device 50.

As has been described in the third embodiment, when the focus evaluation values of the focus-evaluation region are calculated by the focus evaluation portion 54, the AF portion 55 positions the stage 11 at a Z-direction position at which the focus evaluation values reach a maximum.

By doing so, if a display region in the original-size image A displayed on the monitor 30 is changed by the digital zoom operations by the observer, the Z-direction position of the stage 11 is automatically adjusted so that the display region that is actually displayed on the monitor 30 is brought into focus. Therefore, there is an advantage in that the observer can observe the in-focus enlarged image C on the monitor 30 regardless of the positions at which the specimen S is digitally zoomed and used for the enlarged display. Because other effects of this embodiment are the same as those of the first to third embodiments, descriptions thereof will be omitted.

In the first to fourth embodiments, although cases in which the enlargement region B set by the digital zoom portion 51 is the region-of-interest have been described, it is permissible to allow the region-of-interest to be set independent of the digital zoom processing performed by the digital zoom portion 51. For example, it is permissible to allow the observer to set the region-of-interest in an arbitrary region in the image displayed on the monitor 30 by using the input portion 40.

In the first to fourth embodiments, the exposure control portion 52 controls the exposure time of the image-acquisition portion 20 in order to adjust the exposure level of the image-acquisition portion 20; however, instead of the exposure time, or in addition thereto, an arbitrary parameter with which the exposure level can be adjusted may be controlled, such as the light level of the illumination light that is radiated onto the specimen S from the light source 12, the hole diameter of an aperture (not shown) provided in the image-acquisition portion 20, or the like.

### REFERENCE SIGNS LIST

100, 200, 300, 400 microscope system
10 optical microscope
20 image-acquisition portion
30 monitor (display portion)
40 input portion
50 control device
51 digital zoom portion
52 exposure control portion (region-of-interest setting portion)
53 white-balance adjusting portion
54 focus evaluation portion
55 autofocus portion (focus adjusting portion)

1. A microscope system comprising:
an optical microscope for observing a specimen;
an image-acquisition portion that performs image acquisition of an image of the specimen obtained by the optical microscope;
a display portion that displays the image of the specimen acquired by the image-acquisition portion;
a region-of-interest setting portion that sets, in the image of the specimen, a region-of-interest that is being observed by an observer on the display portion; and
an exposure control portion that controls an exposure level of the image-acquisition portion based on a brightness of the region-of-interest set in the image of the specimen by the region-of-interest setting portion.

2. The microscope system according to claim 1, further comprising:
a digital zoom portion that enlarges a portion of the image by means of digital processing and that causes the enlarged portion to be displayed on the display portion,
wherein the region-of-interest setting portion sets the portion to serve as the region-of-interest when the portion that has been enlarged by the digital zoom portion is being displayed on the display portion.

3. The microscope system according to claim 1, further comprising:
a white-balance adjusting portion that adjusts a white balance of the image based on a color of the region-of-interest.

4. The microscope system according to claim 1, further comprising:
a focus evaluation portion that calculates a focus evaluation value that indicates a degree-of-focus of the region-of-interest.

5. The microscope system according to claim 4, further comprising:
a focus adjusting portion that adjusts focus of the optical microscope with respect to the specimen based on the focus evaluation value calculated by the focus evaluation portion.
